(19) United States
(12) Patent Application Publication
(10) Pub. No.: US 2012/0020624 A1
(43) Pub. Date: Jan. 26, 2012

(54) SHIELDED CONNECTOR ASSEMBLY

(75) Inventors: CHI-NAN LIAO, New Taipei (TW); HSIEN-CHU LIN, New Taipei (TW); BING-BO HU, Kunshan (CN)

(73) Assignee: HON HAI PRECISION INDUSTRY CO., LTD., New Taipei (TW)

(21) Appl. No.: 13/189,551

(22) Filed: Jul. 24, 2011

(30) Foreign Application Priority Data
Jul. 23, 2010 (TW) 99214018

(51) Int. Cl. G02B 6/36; H01R 13/648

(52) U.S. Cl. 385/77; 439/607.01

(57) ABSTRACT

An shielded connector assembly (100) includes an insulative housing (1); a plurality of terminals (2) supported by the insulative housing; a metallic shell (7) having frame (71) enclosing the insulative housing, the frame having a top wall (711), a bottom wall (712) and a pair of side walls (713) joining with the top wall and the bottom wall, at least one first locking hole (7112) defined in the top wall and at least one second locking hole (7132) defined in the side wall, and the first locking hole offsetting from the second locking hole along a front-to-back direction.

### FIELD OF THE INVENTION

The present invention generally relates to a connector assembly, and more particularly to a shielded connector assembly adapted for electrical and optical transmitting reliably.

### DESCRIPTION OF PRIOR ART

Many of today's processing systems, such as personal computer (PC) systems, there exist universal serial bus (USB) ports for connecting various USB devices. Some of these USB devices with USB ports are frequently used by PC users. USB-IF has released several versions for USB standard, i.e., USB Spec V1.0, USB Spec V2.0 and USB Spec V3.0, etc. Transmitting speed is increasing with development of electronic technology. Recently, optical transmitting is also applied to common USB connector so as to expand usage thereof.

For example, CN Pub. Pat. No. 101345358 published on Jan. 14, 2009 discloses an optical USB connector assembly which has a fiber device added to a USB connector assembly. The fiber device has a number of fiber wires connected with lenses embedded in the USB connector. Thus, the optical USB connector can transmit electrical signals and optical signals. The USB connector assembly further has a metallic shell with two locking holes defined in a top side thereof. However, the locking holes may not be securely engaged with corresponding latching members of a complementary connector, when the latching members are deformed excessively for using frequently.

Hence, an improved shielded connector assembly is highly desired to overcome the aforementioned problems.

### SUMMARY OF THE INVENTION

Accordingly, an object of the present invention is to provide a shielded connector assembly which is reliably connected with complementary connector.

In order to achieve the object set forth, a shielded connector assembly in accordance with the present invention comprises an insulative housing; a plurality of terminals supported by the insulative housing; a metallic shell having a frame enclosing the insulative housing, the frame having a top wall, a bottom wall and a pair of side walls joining with the top wall and the bottom wall, at least one first locking hole defined in the top wall and at least one second locking hole defined in the side wall, and the first locking hole offsetting from the second locking hole along a front-to-back direction.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of a shielded connector assembly;

FIG. 2 is similar to FIG. 1, but viewed from other direction;

FIG. 3 is an exploded, perspective view of FIG. 1;

FIG. 4 is similar to FIG. 3, but viewed from other aspect;

FIG. 5 is a partially assembled view of the shielded connector assembly;

FIG. 6 is similar to FIG. 5, but viewed from other aspect; and

FIG. 7 is a cross section view of FIG. 1 taken along line 7-7.

### DETAILED DESCRIPTION OF PREFERRED EMBODIMENTS

Reference will now be made in detail to the preferred embodiment of the present invention.

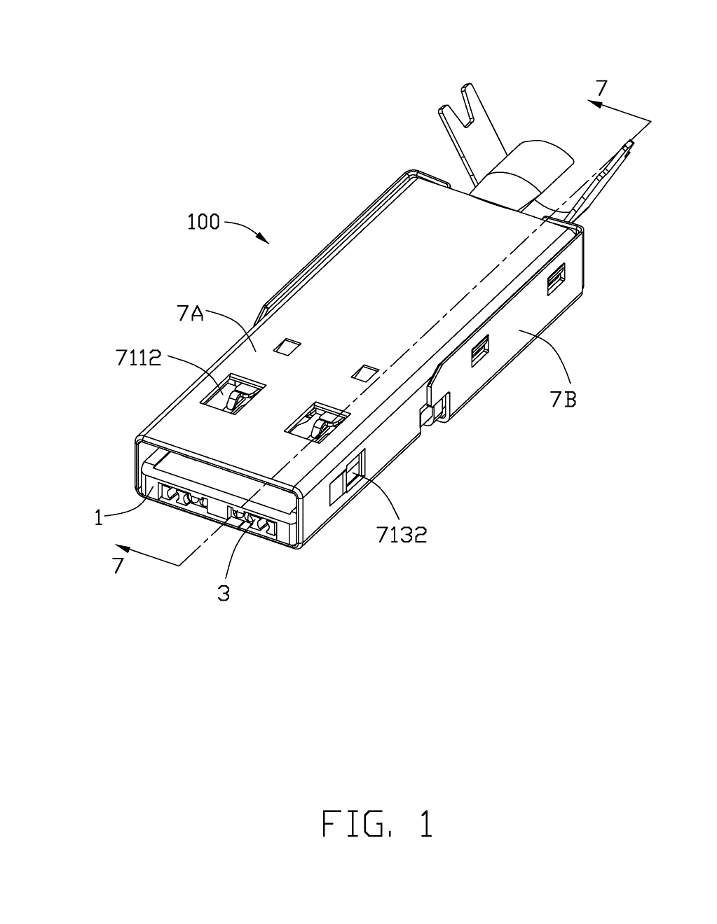

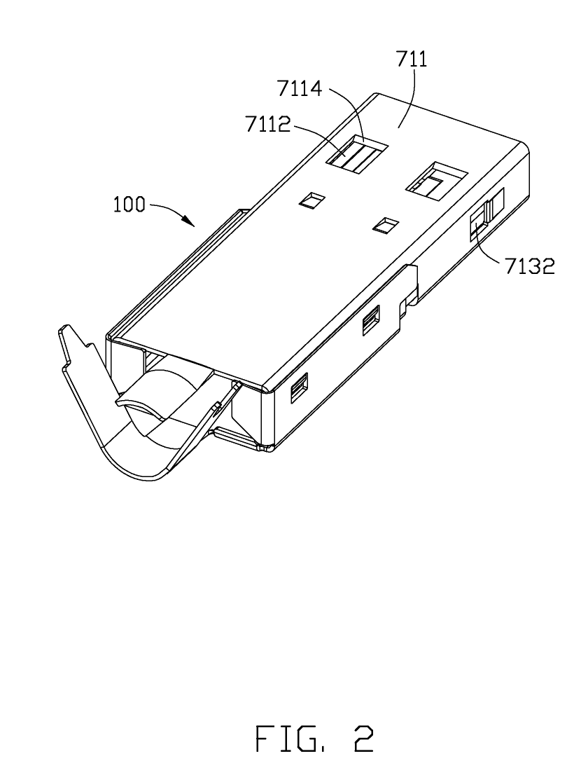

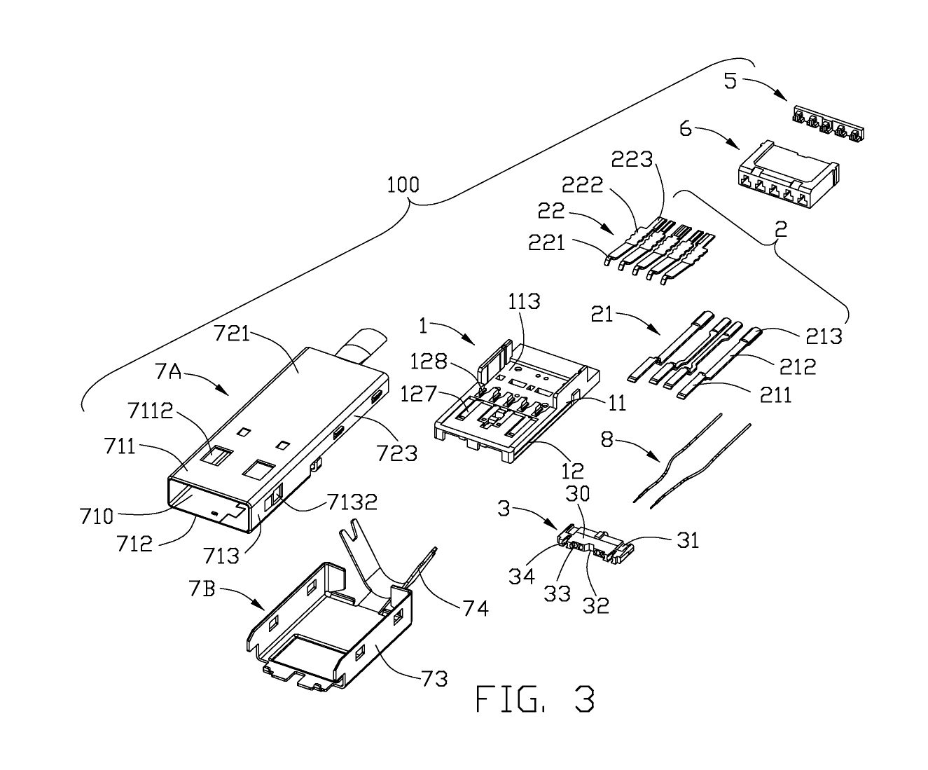

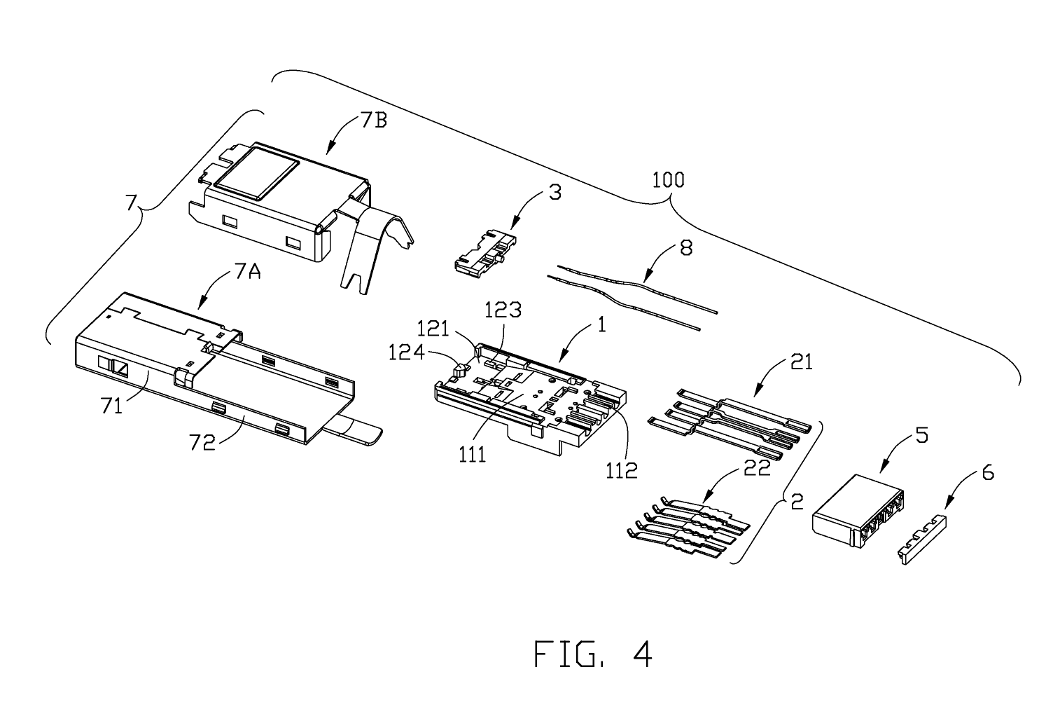

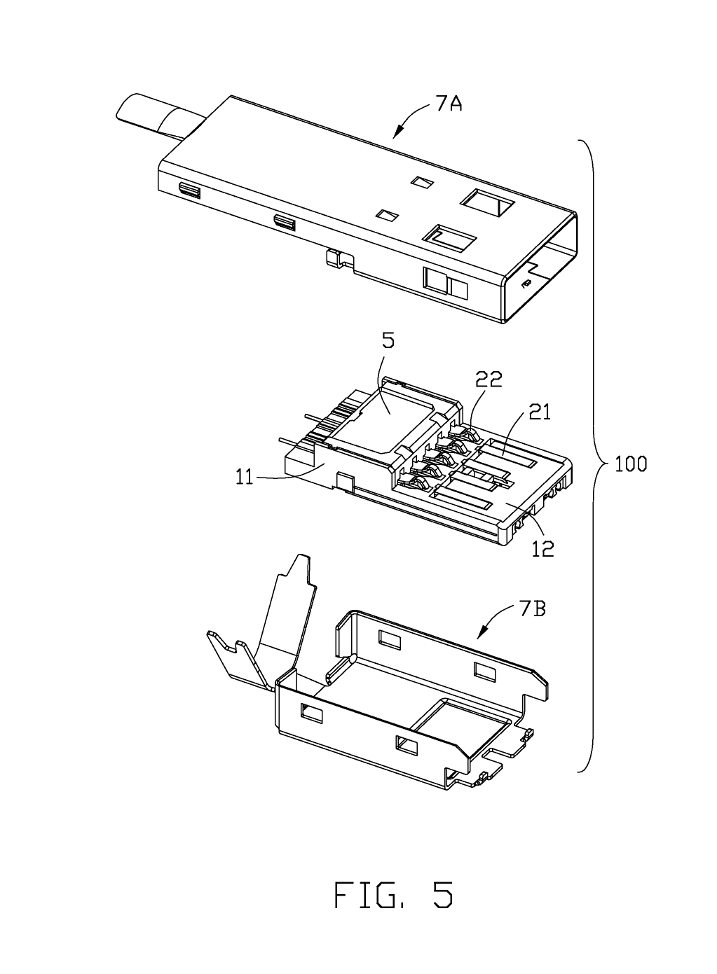

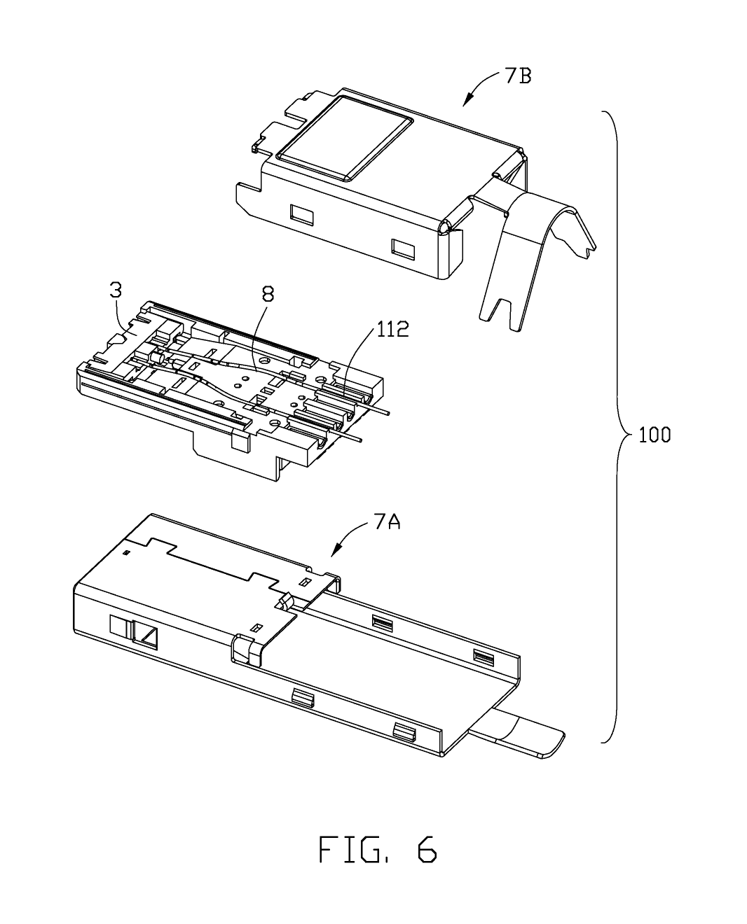

Referring to FIGS. 1-7, a shielded connector assembly 100 in accordance with the present invention comprises an insulative housing 1, a plurality of terminals 2 supported by the insulative housing 1, an optical module 3 mounted to the insulative housing 1, a spacer 5, a terminal seat 6, a metallic shell 7 shrouding the insulative housing 1, a number of fibers 8 connecting with the optical module 3.

The insulative housing 1 includes a main portion 11 and a tongue portion 12 extending forwardly from the main portion 11.

There is a depression 111 located in a lower side of the tongue portion 12 and a front segment of the main portion 11. A number of retaining slots 112 are located in a back segment of the main portion 11 and communicates with the depression 111. There is a recess 113 located in an upper side of the main portion 11. The terminal seat 6 is accommodated in the recess 113. There is a cavity 121 defined in a lower side of a front segment of the tongue portion 12. The cavity 121 is deeper than the depression 111. A tapered stopper 124 is formed on a middle segment of a front portion of the cavity 121. There are a plurality of first terminal grooves 127 and second terminal grooves 128 located in an upper side of the tongue portion 12. The first terminal grooves 127 are spaced apart from the second terminal grooves 128 along a front-to-back direction.

An arrangement of the terminals 2 is in accordance with USB 3.0 standard. The terminals 2 are divided into a set of first terminals 21 and a set of second terminals 22. The first terminals 21 and the second terminals 22 are separated into two distinct rows along the front-to-back direction.

The set of first terminals 21 have four contact members arranged in a row along the transversal direction. Each first terminal 21 substantially includes a planar retention portion 212 supported by a bottom surface of the recess 113, a mating portion 211 raised upwardly and extending forwardly from the retention portion 212 and received in the corresponding first terminal groove 127, and a tail portion 213 extending rearward from the retention portion 212. Furthermore, the mating portion 211 and the tail portion 213 are disposed at opposite sides (top side and bottom side) of the insulative housing 1.

The set of second terminals 22 have five contact members arranged in a row along the transversal direction and combined with the terminal seat 6. The set of second terminals 22 are separated into two pairs of signal terminal for transmitting differential signals and a grounding terminals disposed between the two pair of signal terminals. Each second terminal 22 includes a planar retention portion 222 received in the terminals seat 6, a curved mating portion 221 extending forward from the retention portion 222 and disposed beyond a front surface of the terminal seat 6, and a tail portion 223 extending rearward from the retention portion 222 and disposed behind a back surface of the terminal seat 6. The spacer 5 is assembled to the terminal seat 6, with a number of ribs (not numbered) thereof inserted into the grooves (not numbered) of the terminal seat 6 to position the second terminals 22.

The optical module 3 includes a base portion 30 and a number of lenses 33 arranged in juxtaposed manner and mounted to a base portion 30. In addition, there are two guiding grooves 31 located in lateral parts of a bottom side of the base portion 30. The base portion 30 further defines a cutout 32 in middle segment of a front side thereof. Two alignment holes 34 are respectively located in lateral segments of the front side. The optical module 3 is accommodated in the cavity 121. The guiding members 123 cooperate with the guiding grooves 31, when the optical module 3 moves in the cavity 121. The stopper 124 is accommodated in the cutout 32 to prevent the optical module 3 escaping from the insulative housing 1.

The fibers 8 extend into the depression 111 via retaining slots 112 and are respectively coupled to the lenses 33 of the optical module 3 to form optical signal transmitting path. Corresponding copper wires (not shown) are connected to the tail portions 213, 223 of the first terminals 21 and the second terminals 22 to form electrical signal transmitting path. As the optical module 3 and the terminals 2 are arranged at opposite sides of the insulative housing 1, hence it facilitates manufacturing proceed.

The metallic shell 7 includes a first shell part 7A and a second shell part 7B cooperates together to enclose the insulative housing 1, the terminals 2 and the optical module 3.

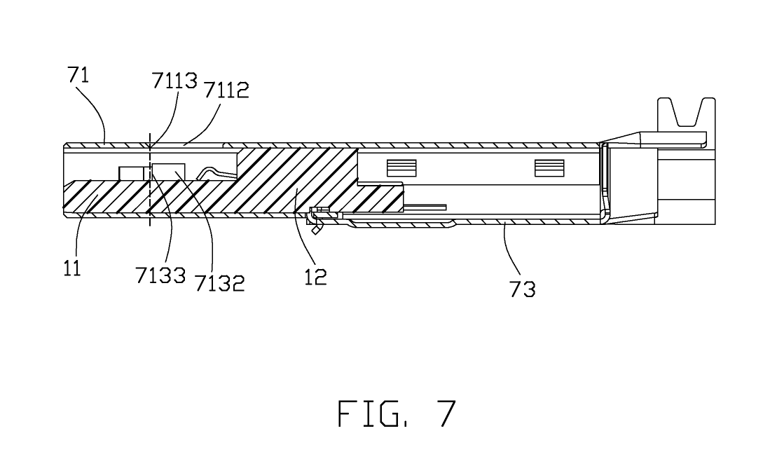

The first shell part 7A has a rectangular shaped frame 71 and an inverted U-shaped portion 72 connected to the frame 71. The frame 71 has a top wall 711, a bottom wall 712 and a pair of side walls 713 joining with the top wall 711 and the bottom wall 712 to form a hollow 710. There are two first locking holes 7112 defined in the top wall 711. The two first locking holes 7112 are spaced apart from each other along a transversal direction. The first locking hole 7112 further defines an inclined front side 7114 which extends fully through a thickness of the frame in an oblique direction rather than partially for efficiently lowering the mating/un-mating forces, compared with the conventional chamfered structure which is only applied to an exterior portion of the locking hole partially. There is a second locking hole 7132 located in each side wall 713. The first locking hole 7112 offsets from the second locking hole 7132 along the front-to-back direction, thus a front edge 7133 of the second locking hole 7132 is located behind a back edge 7113 of the inclined front side 7114, i.e., the front edge 7133 of the second locking hole 7132 is located behind an imagery vertical plane (referring to dashed line in FIG. 7), and the front side 7114 of the first locking hole 7112 is located in front of the imagery vertical plane. As a first distance between the first locking hole 7112 and a front edge of the frame 71, is smaller than or differs from a second distance between the second locking hole 7132 and the front edge of the frame 71; therefore engagement force between the first locking holes 7112, second locking holes 7132 and corresponding latching members of a complementary connector do not reach peak value simultaneously. The inverted U-shaped portion 72 has a top side 721 and two lateral sides 723 projects downwardly from edges of the two lateral sides 723.

The second shell part 7B has a U-shaped portion 73 and a holding portion 74 projecting backwardly from the U-shaped portion 73.

The insulative housing 1 is assembled to the first shell part 7A of the metallic shell 7, with the tongue portion 12 and the front segment of the main portion 11 received in the hollow 710 of the frame 71, the back segment of the main portion 11 accommodated in the inverted U-shaped portion 72. The second shell part 7B is assembled to the first shell part 7A, with the U-shaped portion 73 engaged with the inverted U-shaped portion 72.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A shielded connector assembly, comprising:
an insulative housing;
a plurality of terminals supported by the insulative housing;
a metallic shell having a frame enclosing the insulative housing, the frame having a top wall, a bottom wall and a pair of side walls joining with the top wall and the bottom wall, at least one first locking hole defined in the top wall and at least one second locking hole defined in the side wall, and the first locking hole offsetting from the second locking hole along a front-to-back direction.

2. The shielded connector assembly as recited in claim 1, wherein the first locking hole has a front side located in front of an imagery vertical plane, and the second locking hole has a front edge located behind the imagery vertical plane.

3. The shielded connector assembly as recited in claim 2, wherein the front side is an inclined side which is oblique with an extent fully through a thickness of the top wall.

4. The shielded connector assembly as recited in claim 1, further comprising an optical module mounted to the insulative housing.

5. The shielded connector assembly as recited in claim 4, wherein the insulative housing a main portion and a tongue portion extending forwardly from the main portion, and the optical module is received in a cavity in the tongue portion.

6. The shielded connector assembly as recited in claim 5, wherein the optical module includes a base portion and a number of lenses arranged in juxtaposed manner and mounted to the base portion.

7. The shielded connector assembly as recited in claim 6, wherein there are a number of fibers respectively connected with the lenses.

8. The shielded connector assembly as recited in claim 7, wherein there is a depression defined in the base portion and communicating with the cavity, and the fibers pass through the depression.

9. A shielded connector assembly, comprising:
an insulative housing;
a plurality of terminals supported by the insulative housing;
a metallic shell having a frame enclosing the insulative housing, the frame having a top wall, a bottom wall and a pair of side walls joining with the top wall and the bottom wall, at least one first locking hole defined in the top wall, at least one second locking hole defined in the side wall;
wherein there is first distance between the first locking hole and a front edge of the frame, and there is a second distance between the second locking hole and the front edge of the frame; and
wherein the first distance is different from the second distance.

10. The shielded connector assembly as recited in claim 9, wherein the first distance is smaller than the second distance.

11. The shielded connector assembly as recited in claim 9, wherein there are two first locking holes defined in the top side and spaced apart from each other along a transversal direction.

12. The shielded connector assembly as recited in claim 9, wherein there are two second locking holes respectively defined in the side walls.

13. The shielded connector assembly as recited in claim 9, wherein the first locking hole has an inclined front side.

14. The shielded connector assembly as recited in claim 9, wherein the terminals are divided into two a set of first terminals and a set of second terminals, and mating portions of the first terminals are disposed in front of mating portions of the second terminals.

15. The shielded connector assembly as recited in claim 14, wherein there is an optical module mounted to the insulative housing.

16. The shielded connector assembly as recited in claim 15, wherein the optical module and the mating portions of the terminals are arranged at opposite sides of the insulative housing.

17. A shielded plug connector for use a complementary receptacle connector, comprising:
an insulative housing;
a plurality of contacts disposed in the housing;
a metallic shell including a frame enclosing the housing to form a mating port thereof, the frame defining a first wall and a second wall perpendicular to each other,
a first locking hole formed in the first wall with a first locking edge thereof; and
a second locking hole formed in the second wall with a second locking edge thereof; wherein
at least one of the first locking edge and the second locking edge defines an oblique configuration which extends fully through a full thickness of the frame for efficiently lowering mating-un-mating forces.

18. The shielded plug connector as claimed in claim 17, wherein the first locking edge and the second locking edge are configured to be engaged with or disengaged from corresponding first and second tangs of the complementary receptacle connector at different time.

19. The shielded plug connector as claimed in claim 18, wherein the first locking edge and the second locking are located in different imaginary vertical planes under condition that the corresponding first and second tangs of the complementary receptacle connector are essentially located at a same imaginary vertical plane.
